(19) United States
(12) Patent Application Publication
(10) Pub. No.: US 2016/0012576 A1
(43) Pub. Date: Jan. 14, 2016

(54) REAL TIME MONITORING OF GUIDE VANE POSITIONS WITH A CAMERA

(71) Applicant: Siemens Energy, Inc., Orlando, FL (US)

(72) Inventors: Clifford Hatcher, JR., Orlando, FL (US); James P. Williams, Orlando, FL (US)

(21) Appl. No.: 14/326,499

(22) Filed: Jul. 9, 2014

(51) Int. Cl. G06T 7/00; G06T 7/20; G06T 7/60; F01D 21/00; G06T 1/00

(52) U.S. Cl. CPC G06T 7/004; F01D 21/003; G06T 1/0007; G06T 7/0004; G06T 7/0022; G06T 7/60; G06T 7/20; G06T 2207/10004; G06T 2207/30164

(57) ABSTRACT

An image capturing system includes an imaging device positioned at a location in a stationary portion of a turbo machine, the imaging device having a field of view proximate to one or more vanes of a variable vane stage of the turbo machine and configured to capture an image of the field of view. The system also includes an image analyzer in communication with the imaging device configured to determine an angle of rotation of the one or more vanes of the variable vane stage based on the captured image of the field of view.

### FIELD OF THE INVENTION

The present invention relates to the field of power generating equipment and, more particularly, to monitoring guide vanes in such equipment.

### BACKGROUND OF THE INVENTION

A gas turbine engine generally comprises a compressor section, a combustion section and a turbine section. In the compressor section, a compressor typically includes a series of stages, each stage including a row of stationary stator vanes and a row of rotating blades, used to compress air for later stages. A typical first compressor stage comprises an inlet guide vane stage and can be formed of a plurality of circumferentially arranged inlet guide vanes. The inlet guide vanes may be actuated through a control system so as to optimize air flow for performance.

In some equipment, the inlet guide vanes, as well as other downstream stator vanes, can be variably actuated through the operation of one or more controllable vane actuators. The variable guide vanes can be used to control the flow entering the compressor and are scheduled to open and close as a function of flow demand. The angle of the inlet guide vanes and other variable guide vanes can be changed to meet the requirements of the turbine operating conditions. Normally, the vanes are closed during turbine starting and at low RPM, but they progressively open as the RPM of the turbine increases.

During the operation of the gas turbine, the intake air amount of the compressor can be adjusted by the opening or closing of these inlet guide vane (IGVs) provided at the inlet of the compressor as well as the other variable guide vanes (VGVs). An actuator, such as a servomotor can be controlled by a control system to open or close the IGVs to a desired position. Because such control systems can be imperfect and can include unwanted effects such as hysteresis, an actual position of an IGV may be different than what the control system has determined it should be. Accordingly, there is currently a need for a monitoring system that can accurately determine a position of a variable guide vane during operation of a turbine.

### SUMMARY OF THE INVENTION

One aspect of the present invention relates to an image capturing system that includes an imaging device positioned at a location in a stationary portion of a turbo machine, the imaging device having a field of view proximate to one or more vanes of a variable vane stage of the turbo machine and configured to capture an image of the field of view. The system also includes an image analyzer in communication with the imaging device configured to determine an angle of rotation of the one or more vanes of the variable vane stage based on the captured image of the field of view.

Another aspect of the present invention relates to an image capturing method that includes locating an imaging device at a location in a stationary portion of a turbo machine, the imaging device having a field of view proximate to one or more vanes of a variable vane stage of the turbo machine and capturing an image of the field of view. The method also includes analyzing the image to determine an angle of rotation of the one or more vanes of the variable vane stage based on the captured image of the field of view.

### BRIEF DESCRIPTION OF THE DRAWINGS

While the specification concludes with claims particularly pointing out and distinctly claiming the present invention, it is believed that the present invention will be better understood from the following description in conjunction with the accompanying Figures, in which like reference numerals identify like elements, and wherein:

FIG. 1 is a diagrammatic view illustrating various stages of a turbine engine;

FIG. 2 illustrates a partial view of some of the front stages of a compressor of a turbomachine;

FIG. 3 illustrates a variable vane that can be used in one of the compressor front stages of FIG. 2;

FIG. 4 illustrates an imaging device positioned to monitor a variable vane in accordance with the principles of the present invention;

FIGS. 5A-5C illustrate one embodiment of variable vane monitoring devices in accordance with the principles of the present invention;

FIGS. 6A-6B illustrate another embodiment of variable vane monitoring devices in accordance with the principles of the present invention;

FIG. 7 illustrates a region of a variable vane that can be imaged in accordance with the principles of the present invention; and

FIG. 8 is a flowchart of an example method to determine an angle of a variable vane in accordance with the principles of the present invention.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

Within the present description, various types of vanes having an angle of attack that can be changed are described. The variable vanes can be referred to as intake guide vanes, inlet guide vanes, variable guide vanes, and variable stator vanes. Thus, the principles of the present invention can apply to any of these types of variable vanes.

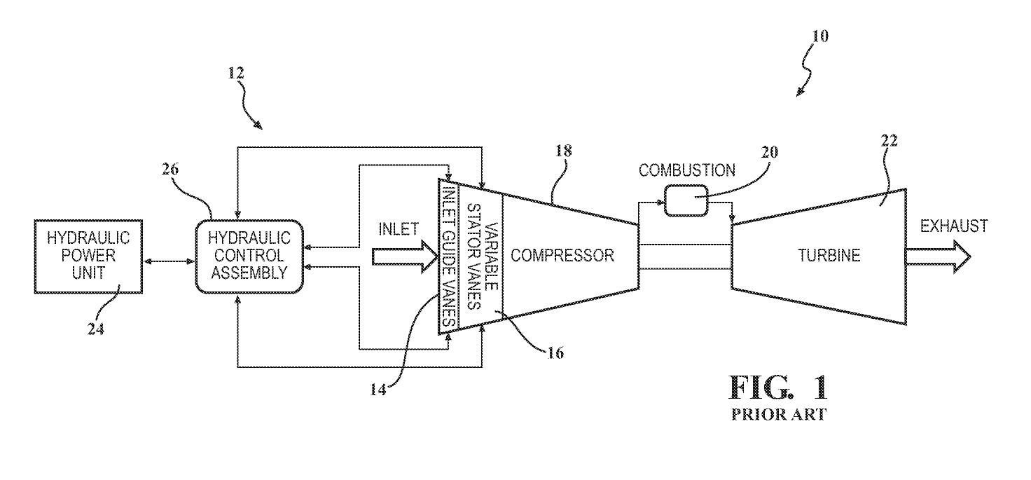

FIG. 1 is a schematic block diagram of a gas turbine, or more generally a turbomachine, 10 including an actuation system for controlling variable guide vanes. One particular type of actuation system could be a hydraulic system such as is shown in FIG. 1, but one of ordinary skill will recognize that servomotor-based, as well as other types of, actuation systems can be used without departing from the scope of the present invention. In the example of FIG. 1, a hydraulic actuation system 12 can be used for independently controlling gas turbine compressor inlet guide vanes (IGVs) 14 and variable stator vanes (VSVs) 16. In a gas turbine or turbomachine, air is pressurized in a compressor and mixed with fuel and ignited in a combustor 20 producing hot combustion gases. The hot combustion gases flow downstream into a turbine 22 including one or more turbine stages that extract energy from the hot combustion gases to produce useful work.

It is desirable to control air flow into the compressor by adjusting positions of the IGVs 14 and the VSVs 16. The actuation system 12 can provide for independently-controllable IGVs 14 and VSVs 16 via hydraulic actuators that can be connected to a hydraulic power unit 24 and controlled by a hydraulic control assembly 26. As mentioned above, alternative types of actuators and control systems can be utilized without departing from the scope of the present invention.

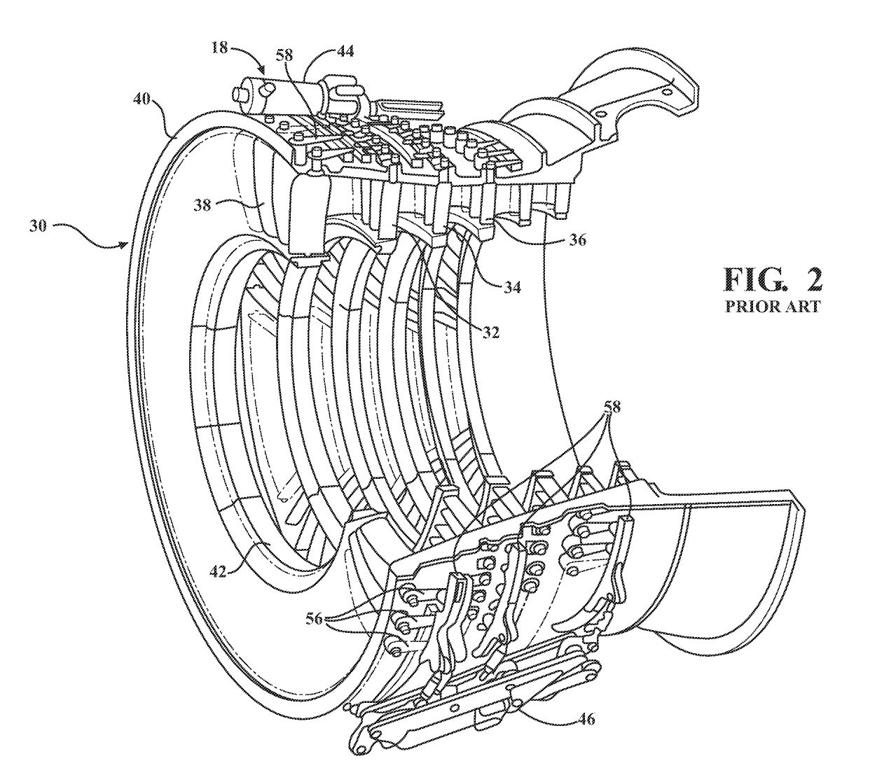

Referring to FIG. 2 the IGVs 14 of the compressor 18 can include an inlet guide vane stage 30 and, optionally, the VSVs 16 can include a set of one or more variable vane stator stages 32, 34, and 36. The annular dimensions of each of stages 30, 32, 34, 36 become increasingly smaller to compress the air for use in following stages of the turbomachine. Each of the stages of the compressor 18 can, for example, include a set of circumferentially arranged vanes 38 captured between a stator case 40 of the compressor 18 and an inner vane shroud 42 or similar inner support structure.

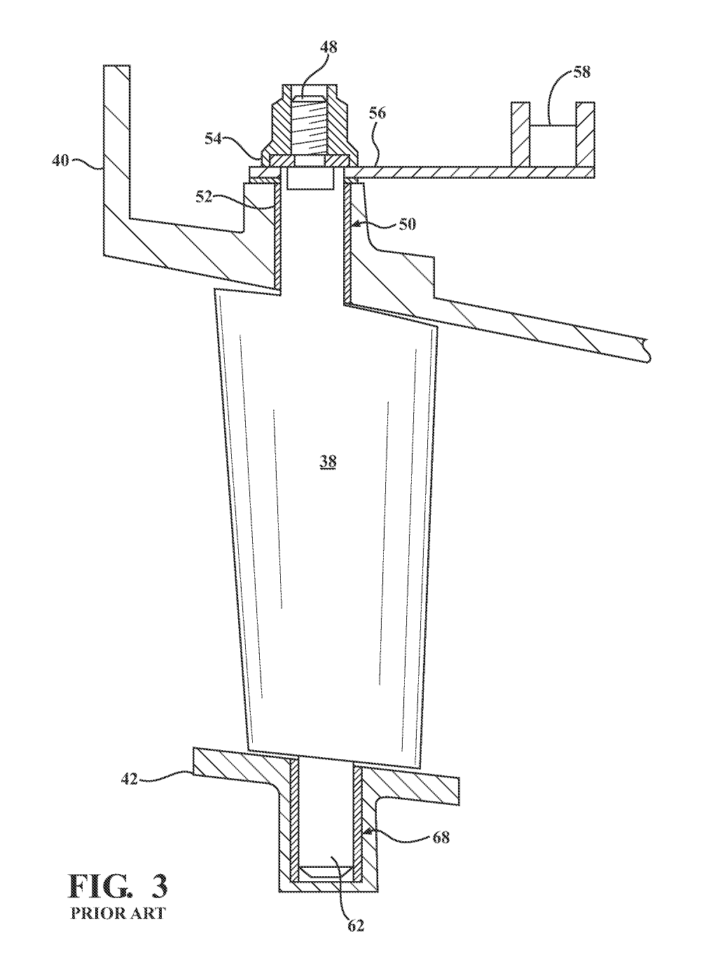

The vanes 38 can be variably actuated by a set of variable vane actuators 44, 46. The vanes 38 can be coupled through the stator case 40 to the actuators 44, 46 by way of a vane outer trunnion 48, as shown in FIG. 3. The outer trunnion 48 passes through a stator case port 50 and can be retained by way of a bushing 52 and an outer nut 54. Further, the vanes 38 can be coupled to the inner vane shroud 42 via an inner trunnion 62 positioned in a port 68 of the inner vane shroud 42. A lever arm 56 can be captured between the bushing 52 and the outer nut 54, and the lever arm 56 can be coupled to the vane actuators 44, 46 through a linkage 58 to effect simultaneous rotation of the vanes 38.

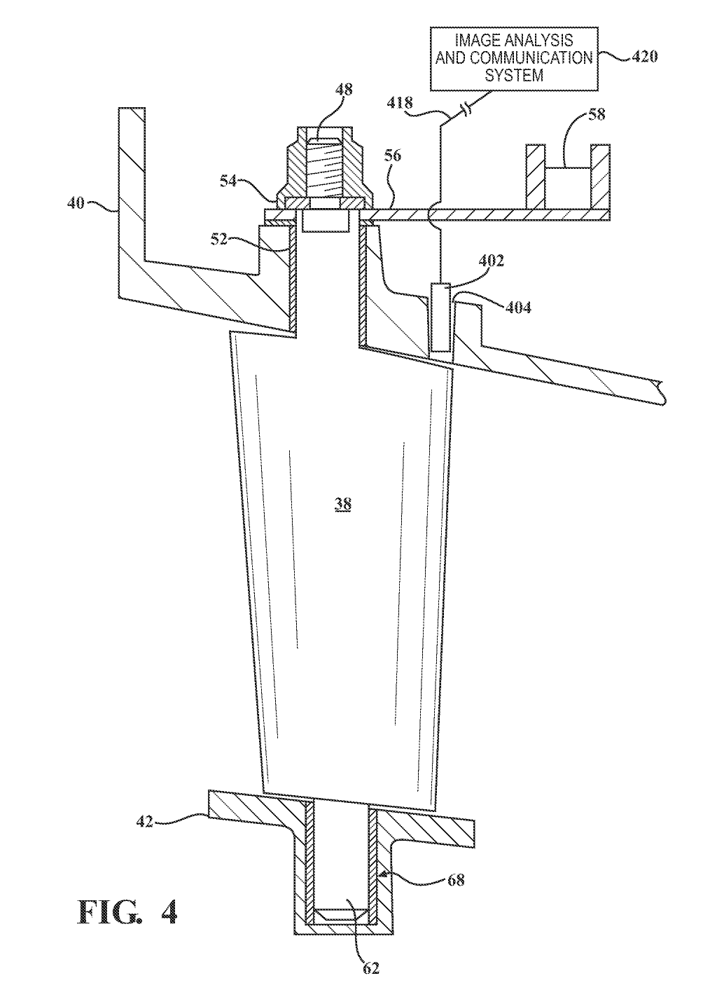

FIG. 4 illustrates how an imaging device can be positioned relative to the vane 38 in order to measure or determine the angle at which the vane is presently rotated.

An opening or view port 404 can be made through the stator case 40 near a trailing edge of the vane 38. An imaging device 402 can then be located so as to be able to capture an image of the trailing edge of the vane 38. The imaging device 402 can include, for example, a camera and an illuminator that extend through the opening 404. The imaging device 402 can include lenses and other optical components that would aid a camera in capturing an image of the vane 38 during normal operation of the turbomachine. The imaging device, for example, can be a camera such as a Logitech C910 or a Dalsa C1600 which can capture an image with a resolution of about 2 megapixels or greater.

In a typical stator case 40, available clearance above the case can be as much as 140 mm which can accommodate an imaging device 402 that extends above the opening 404. The size of the opening 404 can vary based on the particular imaging device 402 being used and any other optical components. However, the opening 404 can, for example, have a diameter of about 16 mm to about 25 mm.

The imaging device 402 can be coupled with a communications channel 418 to communicate a captured image of the vane 38 to processing equipment located remotely from the turbomachine. For example, an image analysis system 420 can receive the captured image of the vane 38 and then determine a current angle of the vane 38. The image analysis system 420 can include a computer or other processor that executes software which can analyze a captured image. In particular, analysis of the captured image can determine if a portion of a variable vane 38 is visible in the image and, if so, then what is the angle of that vane 38 relative to a predetermined reference orientation. The image analysis system 420 can, for example, resolve the angle of the vane 38 with an accuracy of about ±1°.

The image analysis system 420 can also include communication components that can store the captured images, store the analysis determinations, and/or communicate such information to other equipment. For example, the determined angle of the variable vane 38 can be communicated to a variable vane control system (not shown in FIG. 4) to adjust a vane control process based on an actual angle of the variable vane 38.

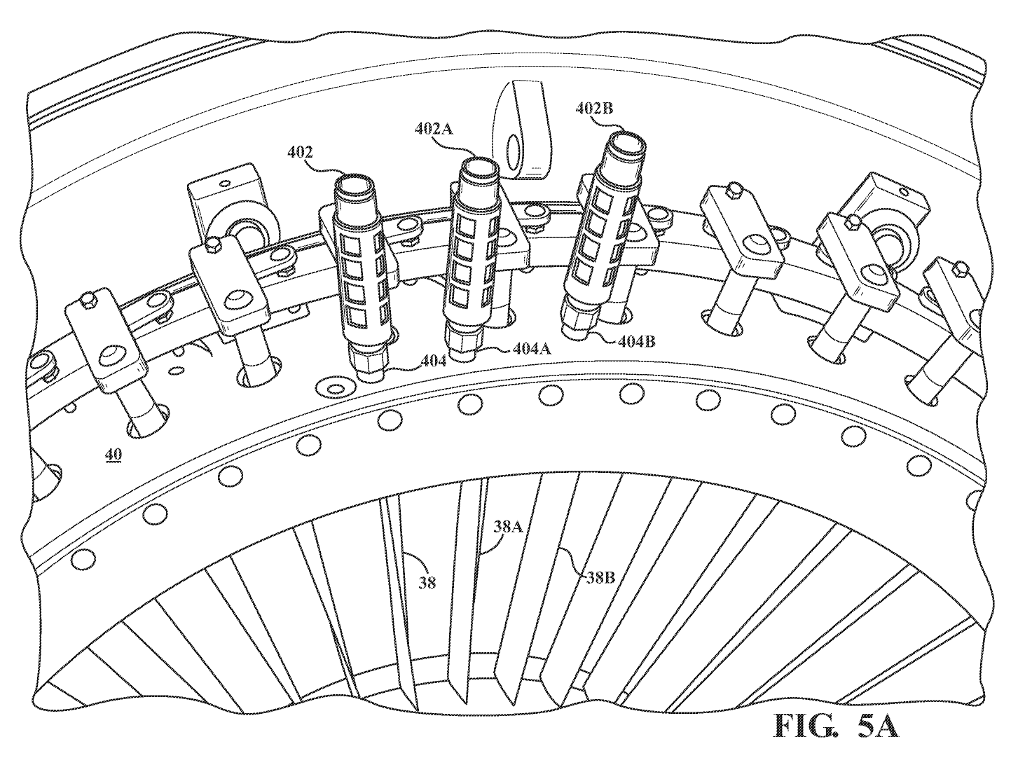

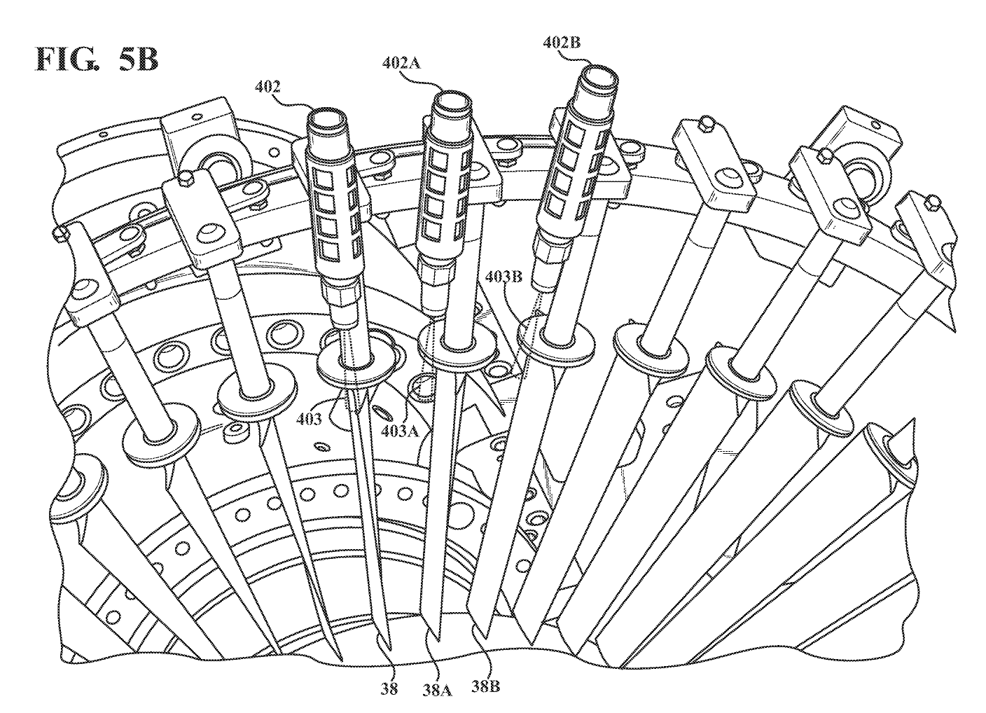

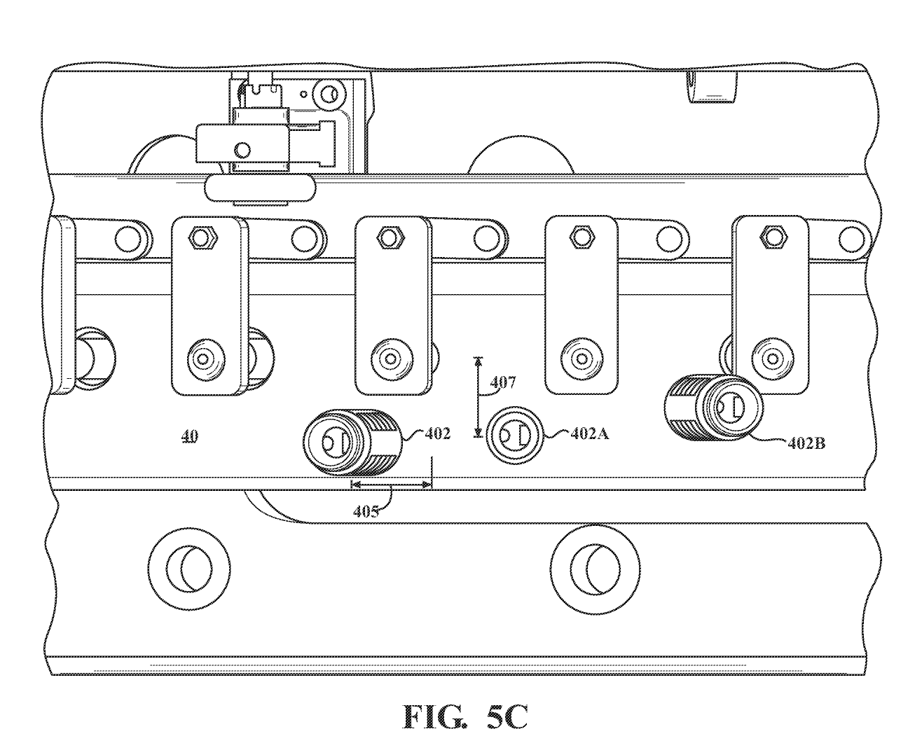

FIG. 5A illustrates an embodiment of the present invention that can utilize multiple imaging devices to determine the angle of a variable vane 38. In FIG. 5A a portion of a variable vane stage is shown that includes a plurality of vanes 38. During operation of the turbomachine, each of these vanes 38 can be rotated so as to be at approximately the same angle.

In FIG. 5A, three cameras or imaging devices 402, 402A, 402B, for example, can be located relative to a respective different vane 38, 38A, 38B. Thus, each camera 402, 402A, 402B has its own respective opening 404, 404A, 404B through the stator casing 40 and is associated with a respective one of the vanes 38, 38A, 38B. Three imaging devices or cameras 402, 402A, 402B are provided merely by way of example and one of ordinary skill will recognize that more cameras or fewer cameras can be provided without departing from the scope of the present invention.

FIG. 5B illustrates the same three imaging devices 402, 402A, 402B of FIG. 5A but without the stator case 40 obstructing a view of the vanes 38, 38A, 38B. Each of the imaging devices 402, 402A, 402B has its own field of view 403, 403A, 403B that represents a region near the vanes 38, 38A, 38B that can be captured in an image. As can be seen in FIG. 5B, the present angle of the vanes 38, 38A, 38B places vane 38 within the field of view 403 of the camera 402. However, vane 38A is not within the field of view 403A of the camera 402A and neither is vane 38B in the field of view 403B of the camera 402B.

The vanes 38, 38A, 38B can rotate, relative to some reference position, through a range of about 45°, for example. While the present invention could use a single imaging device that has a field of view wide enough to capture the trailing edge of a vane through that entire range, multiple imaging devices can be used as well. In the example embodiment being described, the 45° span can be broken into three different portions (with possibly some overlap) so that each imaging device 402, 402A, 402B has a field of view 403, 403A, 403B that is sized so as to capture between about 15° to about 20° of movement of a vane. Each field of view 403, 403A, 403B, however, covers a different portion of the entire 45° span of possible rotation.

For example, if vanes 38, 38A, 38B are rotated about 10°, then vane 38 would be visible in the field of view 403 of camera 402 and vanes 38A, 38B would not be visible in fields of view 403A, 403B, respectively. However, if vanes 38, 38A, 38B are rotated about 40°, then vane 38B would be visible in the field of view 403B and vanes 38, 38A would not be visible in fields of view 403, 403A, respectively.

FIG. 5C illustrates how the openings (not shown) for cameras 402, 402A and 402B can be located at different positions in the stator case 40 relative to a respective vane in order to create a field of view that varies for each camera 402, 402A, 402B. The respective location of a camera 402, 402A, 402B relative to a centerline of a vane can vary from one another in a lateral direction 405 and also in a direction 407 orthogonal to the lateral direction 405. As for an alignment, a camera 402, 402A, 402B can be aligned so that its major axis is substantially parallel with an axis about which its associated vane rotates. Because of the curvature of the stator case 40, the alignment of the cameras 402, 402A, 402B will also vary with respect to one another. However, because the positions of vanes relative to the stator case 40 are known, the positioning of the cameras 402, 402A, 402B can be accomplished so as to create respective fields of view 403, 403A, 403B to capture a vane at various degrees of rotation. Also, because the location of the cameras 402, 402A, 402B are known relative to their associated vanes 38, 38A, 38B, an image from one of the cameras 38, 38A, 38B that includes a portion of a trailing edge of a vane can be analyzed to determine an angle of that vane.

In FIG. 5A-FIG. 5C, each camera 402, 402A, 402B has its own field of view 403, 403A, 403B. However, when considered together, the separate fields of view 403, 403A, 403B define a composite field of view that can capture a variable vane angle for the vanes of a particular stage across the entire angular range that the vane angle can vary. Thus, the three cameras 402, 402A, 402B work in conjunction with one another to form an image capturing device that can measure a vane angle though its entire range of motion. Which particular one field of view 403, 403A, 403B a corresponding vane 38, 38A, 38B is visible in will depend on the angle of the vanes 38, 38A, 38B. Within a captured image of that particular field of view, the location of the vane within that captured image can be determined. The information regarding the particular field of view and the location within that field of view can be used in conjunction with one another to determine the vane angle of the vane in the stage where vanes 38, 38A, 38B are located. The determination of this vane angle can be made while the turbomachine is operating.

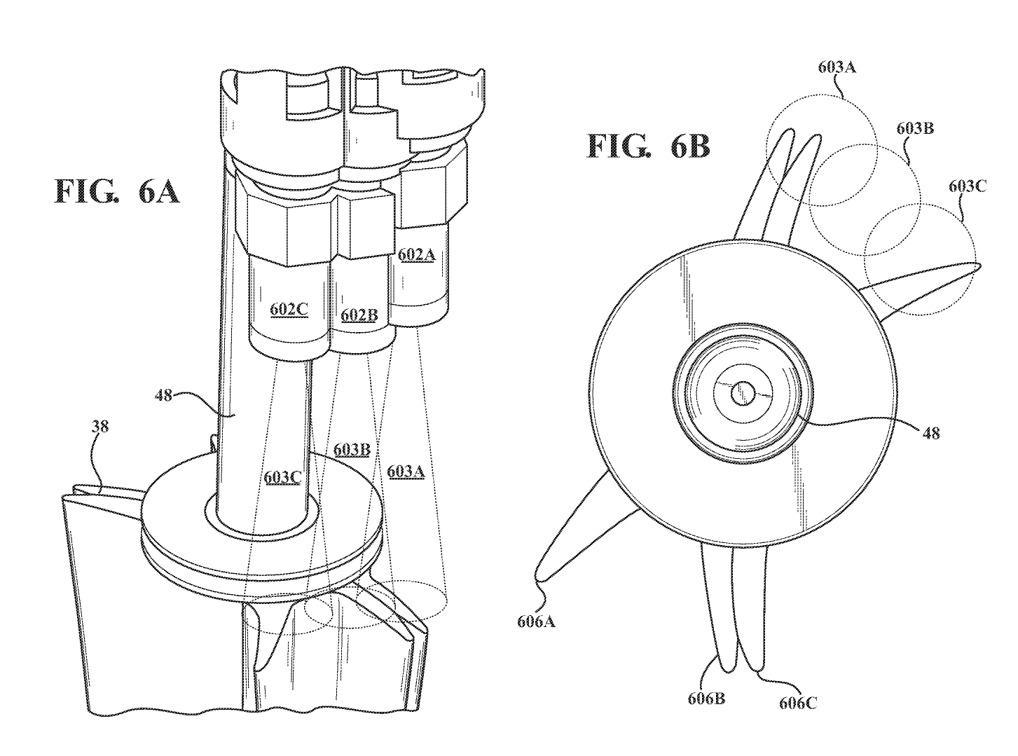

FIG. 6A and FIG. 6B illustrate an alternative to the configuration illustrated in FIGS. 5A-5C. In FIG. 6A, three cameras 602A, 602B, 602C are associated with a single vane. Thus, an opening (not shown) through a stator case would accommodate all three of the cameras 602A, 602B, 602C and these cameras would be oriented to create a composite field of view comprised of their individual fields of view 603A, 603B, 603C. Thus, if the vane is rotated to a position 606A (see FIG. 6B), defining a first angle, then its trailing edge is visible within the field of view 603C. If the vane is rotated to either of positions 606B, 606C, defining a second angle, then it is visible within the field of view 603A. Thus, the cameras 602A, 602B, 602C can capture an image of a portion of the trailing edge of a vane through its entire range of possible movement.

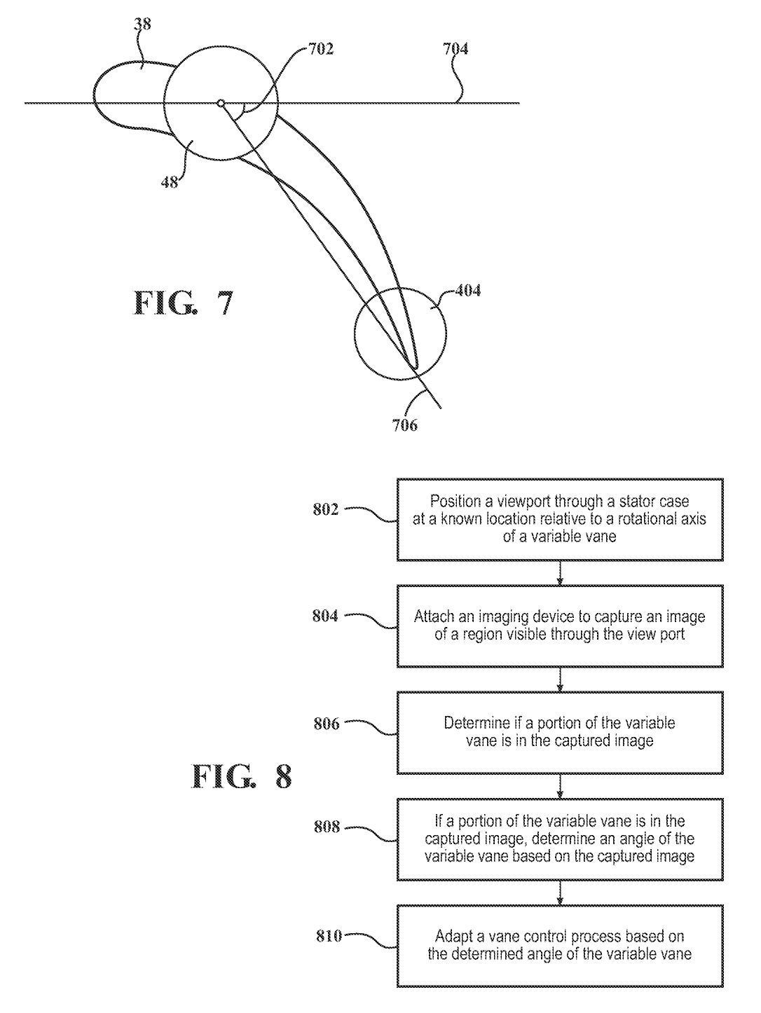

FIG. 7 illustrates a conceptual view of a region of a vane 38 that can be imaged. As explained above, the vane 38 includes a trunnion 48 having a central axis about which the vane 38 can rotate. The opening 404 is located at a known position relative to this rotational axis. A reference position, that passes through the rotational axis can be illustrated by line 704 and provides the reference from which an angle of rotation of the vane 38 can be measured. When a portion of the trailing edge of the vane is visible within a region viewable through the opening 404, then an image capturing that region can be analyzed to identify where that trailing edge portion is located within the image. The identified location of the portion of the trailing edge of the vane 38 can be represented by the line 706 of FIG. 7. An angle 702 formed by the reference line 704 and the identified line 706 can be measured to determine an angle of rotation of the vane 38.

FIG. 8 is a flowchart of an example method to determine an angle of a variable vane of a turbomachine in accordance with the principles of the present invention. Some of the steps of this method can be accomplished by a general purpose computer executing programmable instructions to perform the steps depicted in FIG. 8. One of ordinary skill will recognize that a variety of different hardware, software and a combination of such can be used to perform portions of the flowchart of FIG. 8.

In step 802, an opening or viewport through a stator case of the turbomachine is positioned at a known location relative to a rotational axis of a variable vane. An imaging device, such as a camera, can then be attached to the stator case, in step 804, in order to capture an image of a region visible through the opening or viewport. Once an image is captured, then in step 806, a determination can be made as to whether a portion of the variable vane is visible within the captured image.

In those instances in which a portion of the variable vane is visible within the captured image, a determination can be made in step 808 to identify an angle of rotation of the variable vane. In this way, the angle of a variable vane can be measured or identified during operation of the turbomachine. Accordingly, in step 810, this angular information can be communicated with a control system or other equipment related to the turbomachine.

One of ordinary skill will recognize that there are a variety of different, well-known techniques to analyze images to determine if a predetermined object is in the image. Also, there are various, well-known edge-detection techniques that can be used to determine a location of the vane within a captured image. For performance of steps 806 and 808 described above, one of ordinary skill can select from any of these known image analysis techniques to determine if a portion of a vane is within a captured image and where, specifically, its edges are located in that image. Because of the known relationship between the location of the axis of rotation of the vane and the location of the camera capturing the image, a location of the edges of a vane within an image can be translated into a measured value of the current angle of rotation of that vane.

In the above description, three cameras or imaging devices, for example, were used to determine an angle of a variable vane at one location around a variable vane stage. One of ordinary skill will recognize that the image capturing system described herein can include locating such cameras at multiple locations around a variable vane stage and also at different types of variable vane stages. For example, multiple image capturing systems located around a single variable vane stage can each be used to generate its own respective measurement for a vane angle for that stage. The different respective measurements can then be statistically combined into a single measurement of the vane angle for that stage. In FIGS. 5A-5C the different imaging devices 402, 402A, 402B were associated with adjacent vanes 38, 38A, 38B merely by way of example; one of ordinary skill will recognize that non-adjacent vanes are contemplated within the scope of the present invention. Also, measurements of vane angles, as described herein, can be performed for inlet guide vanes as well as variable guide vanes.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An image capturing system comprising:
an imaging device positioned at a location in a stationary portion of a turbo machine, the imaging device having a field of view proximate to one or more vanes of a variable vane stage of the turbo machine and configured to capture an image of the field of view; and
an image analyzer in communication with the imaging device configured to determine an angle of rotation of the one or more vanes of the variable vane stage based on the captured image of the field of view.

2. The system of claim 1, wherein the one or more vanes of the variable vane stage rotate through an angular range from a first angle to a second angle such that a respective portion of the one or more vanes of the variable vane stage is located within the field of view.

3. The system of claim 2, wherein the imaging device comprises:
a plurality of cameras, wherein each camera has a respective field of view that together define the field of view of the imaging device, and wherein which of the respective fields of view the respective portion of the one or more vanes is located within depends on the angle of rotation of the one or more vanes of the variable vane stage.

4. The system of claim 3, wherein the one or more vanes comprises one vane.

5. The system of claim 3, wherein the one or more vanes comprises a plurality of vanes and each vane is associated with one of the plurality of cameras.

6. The system of claim 3, wherein the plurality of cameras comprises three cameras.

7. The system of claim 2, wherein the respective portion of the one or more vanes comprises a respective trailing edge.

8. The system of claim 3, wherein the image analyzer is configured to determine in which particular one of the respective fields of view the respective portion of the one or more vanes is located.

9. The system of claim 8, wherein the image analyzer is further configured to determine a location of the respective portion of the one or more vanes within the particular field of view.

10. The system of claim 9, wherein the image analyzer is further configured to determine the angle of rotation based on the particular field of view and the determined location within that particular field of view.

11. An image capturing method comprising:
locating an imaging device at a location in a stationary portion of a turbo machine, the imaging device having a field of view proximate to one or more vanes of a variable vane stage of the turbo machine;
capturing an image of the field of view; and
analyzing the image to determine an angle of rotation of the one or more vanes of the variable vane stage based on the captured image of the field of view.

12. The method of claim 11, wherein the one or more vanes of the variable vane stage rotate through an angular range from a first angle to a second angle such that a respective portion of the one or more vanes of the variable vane stage is located within the field of view.

13. The method of claim 12, wherein the imaging device comprises:
a plurality of cameras, wherein each camera has a respective field of view that together define the field of view of the imaging device, and wherein which of the respective fields of view the respective portion of the one or more vanes is located within depends on the angle of rotation of the one or more vanes of the variable vane stage.

14. The method of claim 13, wherein the one or more vanes comprises one vane.

15. The method of claim 13, wherein the one or more vanes comprises a plurality of vanes and each vane is associated with one of the plurality of cameras.

16. The method of claim 13, wherein the plurality of cameras comprises three cameras.

17. The method of claim 12, wherein the respective portion of the one or more vanes comprises a respective trailing edge.

18. The method of claim 13, wherein analyzing the image comprises:
determining in which particular one of the respective fields of view the respective portion of the one or more vanes is located.

19. The method of claim 18, wherein analyzing the image comprises:
determining a location of the respective portion of the one or more vanes within the particular field of view.

20. The method of claim 19, wherein analyzing the image comprises:
determining the angle of rotation based on the particular field of view and the determined location within that particular field of view.
